(19) United States
(12) Patent Application Publication
(10) Pub. No.: US 2003/0180130 A1
(43) Pub. Date: Sep. 25, 2003

(54) Cart and lift system

(76) Inventor: David W. Lutz, Carlisle, PA (US)

Correspondence Address: Lester N. Fortney, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/349,503

(22) Filed: Jan. 22, 2003

Related U.S. Application Data
(60) Provisional application No. 60/351,492, filed on Jan. 24, 2002.

(51) Int. Cl. B65G 67/24

(52) U.S. Cl. 414/385

(57) ABSTRACT

A lift system includes a first base member and a second base member movable relative to the first base member by a first pneumatic lift device. A lift platform is carried on the second base member and includes at least one guide member configured to engage a guide element on a cart to position the cart on the lift system. The system can also include a second lift device to tilt the cart on the lift system.

### CROSS REFERENCE TO RELATED APPLICATION

This application claims the benefits of U.S. Provisional Application Serial No. 60/351,492 filed Jan. 24, 2002, which is herein incorporated by reference in its entirety.

### BACKGROUND OF THE INVENTION

1. Field of the Invention

This invention relates generally to industrial carts and industrial lift systems and, in one embodiment, to a cart and lift assembly configured to raise and/or tilt and/or rotate the cart.

2. Description of the Currently Available Technology

In many industrial applications, manufacturing components, such as parts for use on an assembly line, are packed in large shipping containers and shipped from one location to another, such as from a manufacturer to an assembly facility. Typically, the parts are placed in layers in the shipping container with the layers separated by packing material. The shipping container can be moved to a workstation at the assembly facility where the parts are unpacked and used by a worker on an assembly line. This movement is typically done using a conventional motorized vehicle, such as a forklift truck. At the workstation, the container is typically removed from the vehicle and placed on the floor. The container is opened and the top packing layer is removed to expose the top layer of parts. This top layer of parts can then be removed from the shipping container until all of the parts in this layer are gone. The next layer of packing material can then be removed to expose the underlying layer of parts and these parts can also be removed. Depending upon the size of the parts and the size of the shipping container, several layers of parts can be packed in one container.

While expedient for shipping of the parts, one drawback of this system is that as the upper layers of parts are removed, the remaining layers of parts become more and more inaccessible since they are lower in the container. If the container is simply placed on the floor near the workstation, the worker removing the parts must bend lower and lower to access and remove each successive layer of parts. Further, as the layers of parts are removed, the lower layers of parts on the side of the container opposite to where the worker is standing may be beyond the reach of the worker. Therefore, the worker may have to walk around the container to get the parts on the other side. This consumes valuable time which could be more productively used in the actual manufacturing or assembly process.

Additionally, one of the most common reasons for: industrial injuries is workers being struck by forklift trucks. It can be difficult for a forklift truck operator to obtain a clear field of vision when driving a loaded forklift truck. Also, forklift truck operators can sometimes overlook safety procedures when hurrying to move a load of parts from one location to another on an assembly line floor.

Therefore, it would be advantageous to provide an apparatus and/or method of transporting a container of parts from one location to another while improving the access of a worker to the open container at a workstation. It would also be advantageous to provide an apparatus and/or method of transporting and accessing parts which reduce or eliminate at least some of the need for motorized forklift trucks.

### SUMMARY OF THE INVENTION

A lift system comprises a cart having at least one guide element and a lift system having a movable platform. At least one guide member is connected to the platform. The guide element and guide member are configured such that when the cart is moved toward the platform, the guide element on the cart interacts with the guide member on the platform to position the cart on the lift system.

Another lift system comprises a first base member and a second base member. A first pneumatic lift device is configured to elevate the second base member with respect to the first base member. A lift platform is attached to the second base member. The lift system further includes at least one guide member.

A further lift system comprises a first base member and a second base member. A first pneumatic lift device is configured to elevate the second base member with respect to the first base member. The first lift device can include at least one pneumatic lift bag. A lift platform is attached to the second base member. A second pneumatic lift device is located between the second base member and the lift platform. The second lift device is configured to tilt the lift platform. The second lift device can include at least one pneumatic lift bag. The lift system can include at least one guide member.

An additional lift system comprises a first base member and a second base member. A first pneumatic lift device is configured to elevate the second base member with respect to the first base member. A lift platform is attached to the second base member and can include at least one guide member. A rotation device can be attached to the first base member.

A method of supplying parts comprises providing a cart having at least one guide element and providing a lift system. The lift system can include a first base member, a second base member, and a lift device located between the first and second base members and configured to elevate the second base member with respect to the first base member. The lift system can further include a lift platform carried on the second base member and a guide member. The method can include moving the cart such that the guide element interacts with the guide member to position the cart over the lift system and activating the lift system to raise and/or tilt and/or rotate the cart on the lift system.

### BRIEF DESCRIPTION OF THE DRAWINGS

The general concepts of the invention will be described with reference to the following drawing figures where like reference numbers identify like parts throughout.

FIGS. 1 and 2 are front perspective and bottom perspective views, respectively, of an industrial cart incorporating features of the invention;

FIGS. 3 and 4 are rear perspective and bottom views, respectively, of the cart of FIGS. 1 and 2;

FIG. 5 is a plan view of the cart of FIG. 1;

FIGS. 6 and 7 are front and side views, respectively, of the cart of FIG. 5;

FIGS. 8 and 9 are front perspective and plan views, respectively, of a lift system of the invention in a lowered or retracted position;

FIGS. 10, 11, and 12 are side, front perspective, and front views, respectively, of the lift system of FIG. 8 in an elevated and inclined position;

FIG. 13 is a side view of the lift system of FIG. 8 showing the placement of a cart of the invention;

FIG. 14 is a front view of the cart and lift system of FIG. 13;

FIG. 15 is a side view of the cart and lift system of FIG. 13 in an elevated and inclined position;

FIGS. 16 and 17 are side and front perspective views, respectfully, of another lift system of the invention; and

FIGS. 18 and 19 are side views of the lift system of FIGS. 16 and 17 in collapsed and elevated positions showing the placement of a cart of the invention.

### DESCRIPTION OF THE PREFERRED EMBODIMENTS

As used herein, spatial or directional terms, such as “top”, “bottom”, “left”, “right”, “up”, “down”, “front”, “rear”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10.

An exemplary cart and an exemplary lift system of the invention will first be described and then a method of utilizing these components to transport and position a shipping container will be described. However, it is to be understood the exemplary cart and lift systems are presented simply to disclose the general concepts of the invention and that the invention is not limited to the specifically disclosed embodiments.

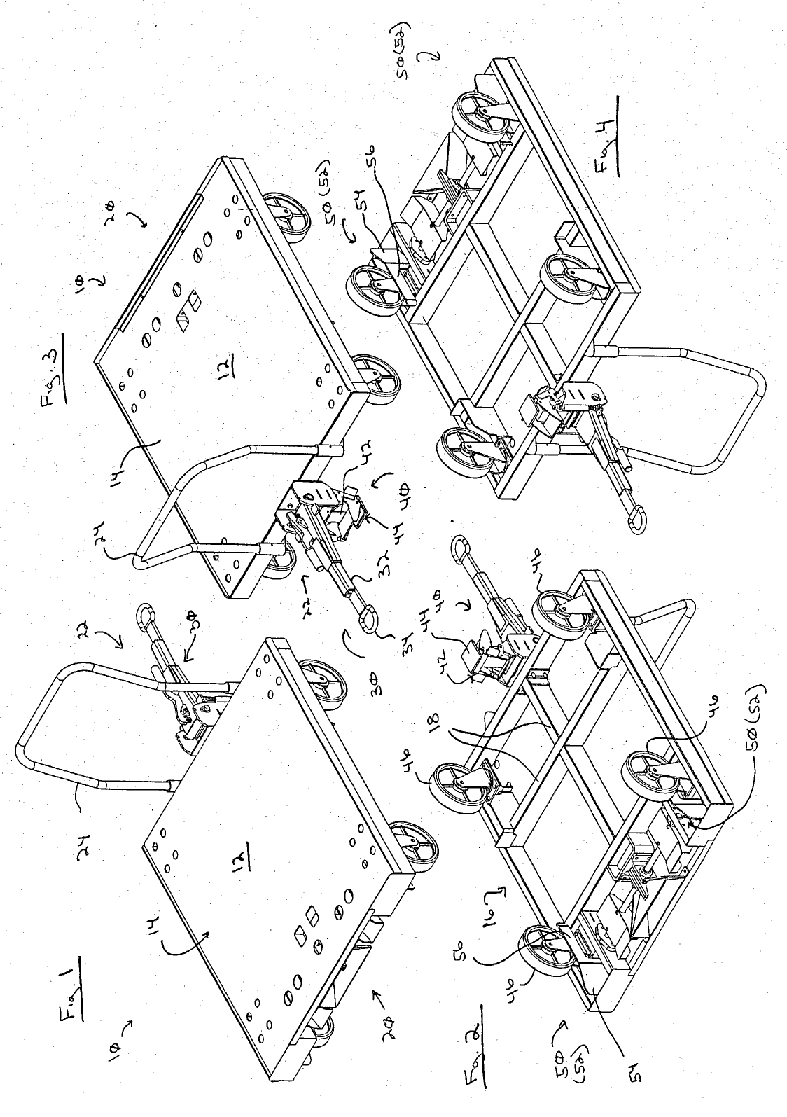

An exemplary cart 10 incorporating features of the invention is shown in FIGS. 1-7. The cart 10 includes a support platform 12 having a top side 14 and a bottom side 16. The platform 12 can be of any shape, but in the illustrated embodiment is rectangular. The platform 12 can be supported on a framework, with support beams 18 carried on the framework to support the platform 12. The cart 10 can also define a front end 20 and a rear end 22. A conventional handle 24, such as a U-shaped handle, can be permanently or removably attached at one end of the cart 10, such as at the rear end 22. Typically, the platform 12, framework, support beams 18, and handle 24 can be made out of metal, such as steel, aluminum, or other metals common in the art.

As shown particularly in FIG. 3, a towing tongue 30 can be attached at one end of the cart 10, such as at the rear end 22, e.g., near the handle 24. The towing tongue 30 can include a retractable, telescopic, or movable member or shaft 32 with a towing element 34 attached at the outer end of the shaft 32. Additionally, the cart 10 can include a conventional braking device 40, such as but not limited to a vertically movable shaft 42 with a foot 44 at the lower end and configured to press downwardly against the floor when engaged to keep the cart 10 from rolling when the brake is in the engaged position (i.e., when the foot 44 is in contact with the floor). When the brake is disengaged, the foot 44 is positioned above the floor (see FIG. 7).

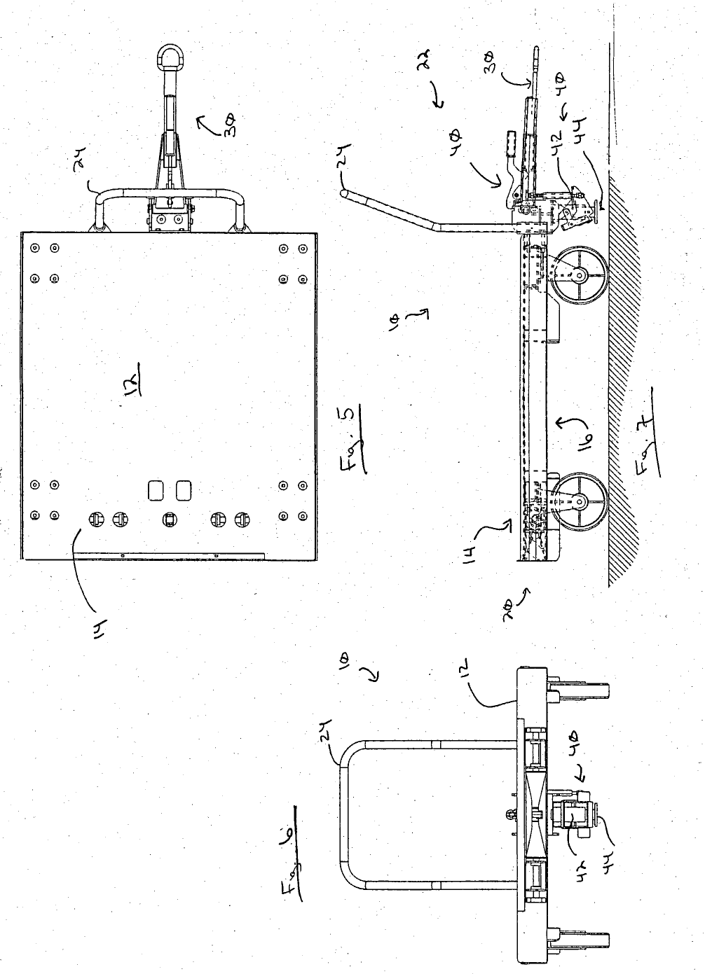

As shown particularly in FIGS. 2 and 4, the cart 10 can also include a plurality of wheels 46 attached to the bottom side 16 of the cart 10 in any conventional manner. These wheels 46 can be of any type, such as but not limited to conventional caster-type wheels well known in the art. The cart 10 can also include at least one, for example two, guide elements 50 configured to interact with, e.g., contact or engage, the lift system of the invention to position the cart 10 on the lift system as described in more detail below. In the embodiment shown in FIGS. 2 and 4, two guide elements 50 are configured as guide plates 52 located on the bottom 16 near the front end 20 of the cart 10, e.g., adjacent, e.g., interior of, the two front wheels 46 of the cart 10. The guide plates 52 can extend beyond, e.g., below, the framework of the cart 10 and can include a first (front) element or portion 54 which is shaped or bent outwardly with respect to the cart 10 and a second, substantially planar, rear element or portion 56 extending from the first portion 54 towards the rear end 22 of the cart 10. Thus, the first portion 54 is angled with respect to the second portion 56. The guide plates 52 can be of any material, such as metal, and can be of any dimensions to function as described below. While in the illustrated embodiment the guide elements 50 are in the form of guide plates 52, the invention is not limited to this specific structure. Any element or structure configured to guide or position the cart 10 on the lift system as described below could be used.

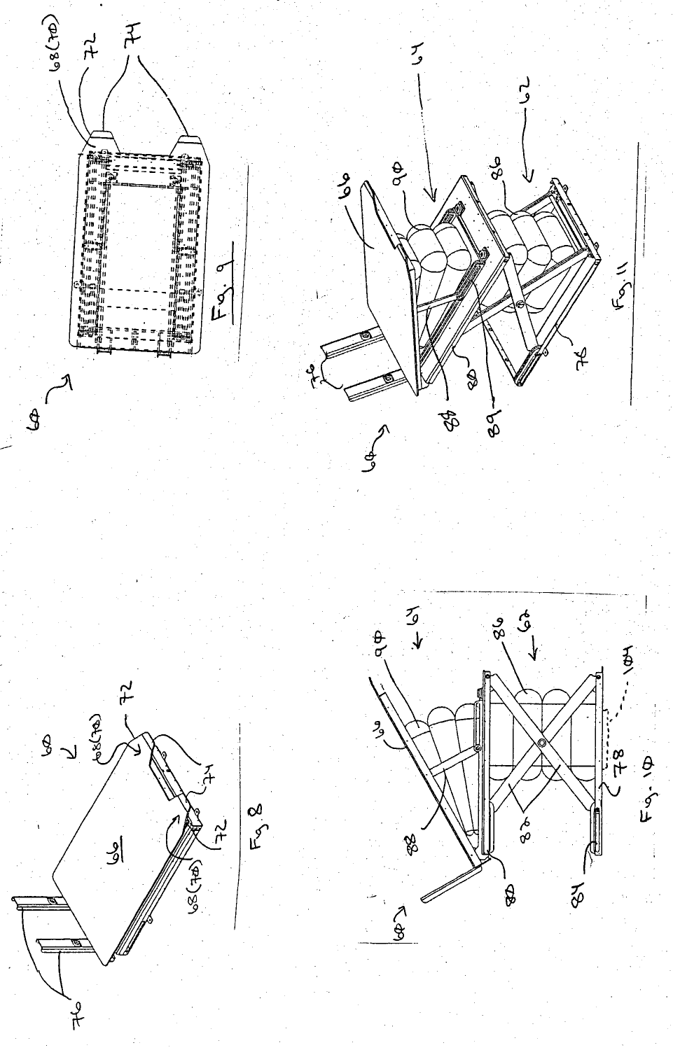

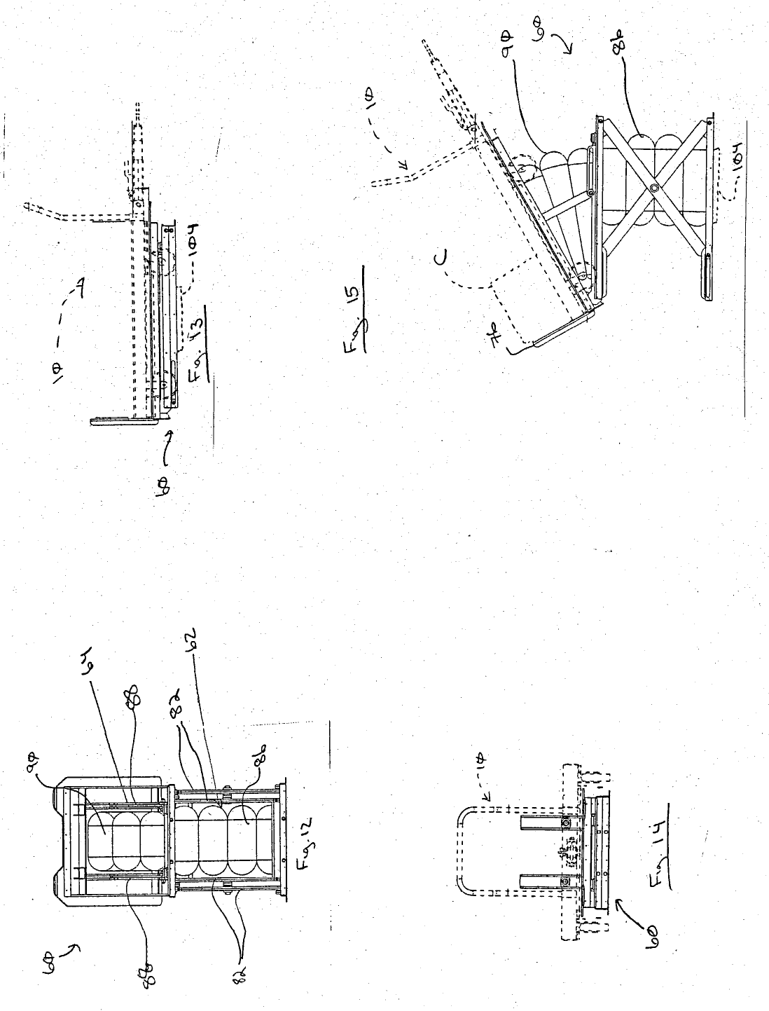

An exemplary lift system 60 of the invention is shown in FIGS. 8-15. The lift system 60 includes a framework having a lower or first lift assembly 62 and an upper or second lift assembly 64 (see FIG. 10). The lift system 60 includes a lift platform 66 having a top surface, e.g., a substantially planar top surface. The lift system 60 can also include at least one guide member 68 (best shown in FIGS. 8 and 9) configured to interact with, e.g., engage, the guide element(s) 50 on the cart 10 as discussed below. In the embodiment shown in FIGS. 8 and 9, the guide members 68 are configured as two projections 70 extending from the front of the lift platform 66. The projections 70 can include a tapered outer edge 72 and a downwardly projecting lip 74. A pair of stops 76, such as upwardly extending rods or frame members, can be attached at the rear end of the lift platform 66.

As shown in FIGS. 10 and 11, the lower lift assembly 62 can include a lower base member 78 and an upper base member 80 movable towards and away from each other. For example, the lower lift assembly 62 can include a plurality of pivotally and slidably mounted cross members 82 attached to the base members 78 and 80. In the illustrated exemplary embodiment, the right ends of the cross members 82 can be pivotally attached to the upper and lower base members 80, 78, respectively. The left ends of the cross members 82 can include a pin, projection, post, or similar member which can be slidable in a groove or track 84, 89 located on or attached to the base members 78, 80, respectively. A first lift device 86 can be positioned between the two base members 78, 80 and, as will be described below, can be configured to elevate or move the second base member 80 with respect to the first base member 78. The lift device 86 can be of any conventional type, such as but not limited to a mechanical screw, a scissors-type lifting mechanism, a hydraulic jack, an electrical lifting arm, or a pneumatic lift device. In the illustrated embodiment, the lift device 86 is a pneumatic device comprising one or more conventional lifting bags which, when inflated, lift or elevate the upper base member 80 away from the lower base member 78. Suitable lifting bags are commercially available from Carter Lift Bag, Inc. of Enumclaw, Wash.

As shown in FIGS. 10-12, the lift platform 66 can be connected to the top base member 80, e.g., by a pair of spaced supports 88. In the illustrated exemplary embodiment, the tops of the supports 88 can be pivotally attached to the bottom of the lift platform 66 and the bottoms of the supports 88 can be slidably mounted in a slot or track 89 located on the upper base member 80. As also shown in FIG. 10, a second lift device 90 can be positioned between the upper base member 80 and the lift platform 66. The second lift device 90 can be of any conventional type and can move or elevate the lift platform 66 with respect to the second base member 80. For example, the second lift device 90 can be configured to tilt or incline the lift platform 66 with respect to the second base member 80 (or with respect to the floor on which the lift system 60 is resting). In the illustrated exemplary embodiment, the second lift device 90 includes one or more substantially wedge-shaped pneumatic lift bags. By “wedge-shaped” is meant that when viewed in side view (such as in FIG. 10), the lift bag(s) provide a sloped or inclined upper surface when inflated. Suitable lifting bags are commercially available from Carter Lift Bag, Inc. of Enumclaw, Wash.

Before discussing further embodiments of the invention, operation of the cart 10 with the lift system 60 of the invention will first be described. As will be appreciated by one skilled in the art, a shipping container having a plurality of layers or parts can be loaded onto carts 10 at a designated loading area. For example, workers can unload shipping containers from storage or from trucks and load the containers onto carts 10. The carts 10 can be wheeled to a desired location on the factory floor for removal of the parts. For example, the carts 10 can be pushed to a workstation having a lift system 60. The carts 10 can be pushed by an operator using the handle 24 or, alternatively, towed by an industrial truck using the towing tongue 30. If needed, the braking device 40 on the cart 10 can be engaged and disengaged during this transit operation to prevent the cart 10 from rolling or moving during intermediate stops.

As shown in FIG. 13, when the cart 10 reaches a desired location, such as the workstation where the lift system 60 is located, the cart 10 can be positioned over the top of the lowered lift system 60 such that the bottom side 16 of the cart platform 12 is above the top of the lift platform 66. By “lowered lift system” is meant the lift devices are in their lowered or collapsed position such that the lift system 60 presents a low profile on the assembly line floor. In order to facilitate correct placement of the cart 10, as the cart 10 is pushed toward the front of the lift platform 66, the guide elements 50 (e.g., guide plates 52) on the bottom of the cart 10, particularly the outwardly angled first portions 54, engage the tapered outer edges 72 of the projections 70 on the lift platform 66. This assists in correctly aligning the cart 10 for further movement onto the lift platform 66. As the cart 10 is pushed farther forward, the tapered sides 72 of the guide members 68 of the lift platform 66 slide along the guide elements 50 of the cart 10 so that the second portions 56 of the guide elements 50 of the cart 10 thereafter slide along the sides of the lift platform 66 to align the cart 10 on top of the lift platform 66. The cart 10 can be pushed onto or over the lift platform 66 until the front of the cart 10 contacts the stops 76 on the back of the lift platform 66 (as shown by dashed lines in FIG. 13).

With the cart 10 thus positioned over the lift system 60, a worker can begin removing parts from the shipping container. When the level of the parts in the shipping container drops below a point where it is no longer easy for the worker to remove the parts, the lift system 60 (e.g., the first and/or second lift devices 86, 90) can be used to elevate and/or tilt the cart 10 to permit easier access to the inside of the shipping container. For example, the lower lift device 86 can be activated to move the top base member 80 away from the lower base member 78 and thus elevate the cart 10. For example, the first lift device 86 can be partially or fully inflated. As will be understood by one skilled in the art, as the lower lift device 86 is activated, the cross members 82 between the first and second base members 78, 80 pivot and slide to permit the second base member 80 to move away from the first base member 78. In order to tilt the cart 10, the second lift device 90 can be activated to tilt the lift platform 66 and, hence, the cart 10 and container C resting thereon (as shown in dashed lines) in FIG. 15. For example, the second lift device 90 can be partially or fully inflated. The shipping container C resting on the cart 10 may slide forward due to the influence of gravity. However, the shipping container C will be stopped from further sliding by contacting the stops 76 on the rear end of the lift platform 66. When the parts are removed, the first and/or second lift devices 86, 90 can be deactivated, retracted, or deflated to lower the cart 10 back onto the floor for removal from the lift system 60 and replacement with another loaded cart 10.

The cart 10 and or lift system 60 can have any desired dimension. In one non-limiting embodiment, the cart platform 12 can have dimensions in the range of 50 to 60 inches (127 cm to 152 cm) long by 45 to 55 inches (114 cm to 140 cm) wide. The bottom 16 of the cart 10 can be about 10 to 13 inches (25 cm to 33 cm) above the floor. In one exemplary embodiment, the lift platform 66 can have a length of about 50 to 65 inches (127 cm to 165 cm) and a width of about 30 to 50 inches (76 cm to 127 cm). The lift system 60 can have a collapsed or lowered height of between 7 to 12 inches (18 cm to 30 cm). In one embodiment, the first lift device 86 can be configured to elevate the upper base member 80 about 30 to 40 inches (76 cm to 102 cm) above the floor. The second lift device 90 can be configured to tilt the lift platform at an angle of between about 2° to 90°, such as between 5° to 45°. The second lift device 90 can also elevate the lift platform 66 such that the front end of the lift platform is between about 35 to 70 inches (89 cm to 178 cm) above the floor.

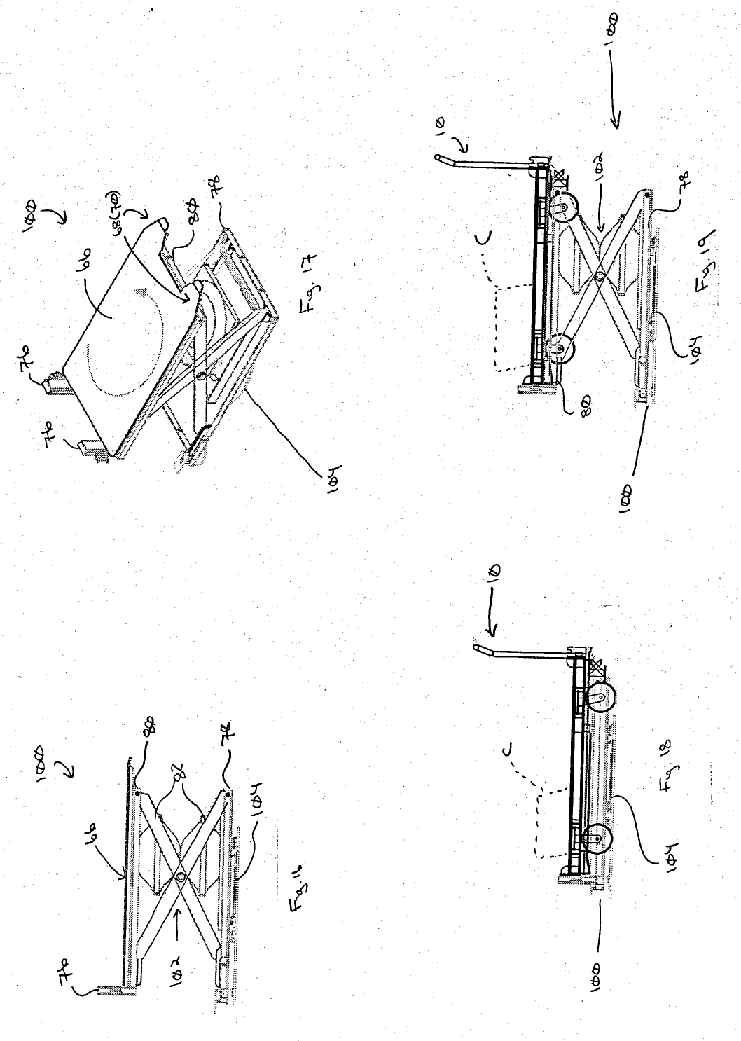

Another lift system 100 is shown in FIGS. 16-20. The lift system 100 is similar to the lift system 60 and can include a lower base member 78 and an upper base member 80 movable relative to each other as described above. A lift device 102 similar to the first lift device 86 described above can be located between the upper and lower base members 80, 78. However, in this embodiment, the lift platform 66 is connected to the upper base member 80 without the intervention of a tilting or second lift device 90 as in the embodiment described above. The lift system 100 can further include a rotating or turning device, such as a turntable 104 connected to the bottom of the lower base member 78. The turntable 104 can be any device to permit turning or rotating the lift system 100. In one embodiment, the turntable 104 can be a commercially available ROTEC® turntable.

As will be appreciated from FIGS. 18 and 19, a cart 10 having a container C, such as that described above, can be positioned over the lift system 100 in the lower position (see FIG. 18). When desired by a worker, the cart and, hence, the container C thereon can be elevated by activating the lift device 100 to provide easier access to the parts. For example, the lift device 100 can be partially or fully inflated. In order to access parts at the sides or at the rear of the container, the worker can rotate the lift system 100 either manually or using a powered device on the turntable 104 as needed to access these parts. When the container C is empty, the lift device 100 can be deactivated or lowered and the cart 10 removed and replaced with a new, loaded cart 10.

The present invention provides a useful and functional method and apparatus for transporting and/or positioning shipping containers or other items. In the cart and lift system of the invention, the lift platform 66 of the lift system 60, 100 contacts and presses against the bottom of the cart 10, not the cart handle 24, to provide a larger surface area to absorb the weight of the cart 10 and any shipping containers supported thereon.

It will be readily appreciated by those skilled in the art that modifications may be made to the invention without departing from the concepts disclosed in the foregoing description. For example, as shown in FIG. 15, a turntable 104 such as described in the lift system 100 could also be incorporated into the lift system 60. Accordingly, the particular embodiments described in detail herein are illustrative only and are not limiting to the scope of the invention, which is to be given the full breadth of the appended claims and any and all equivalents thereof.

What is claimed is:

1. A lift system, comprising:
a cart having at least one guide element; and
a lift system having a movable platform with at least one guide member connected to the platform, with the guide element and guide member configured such that when the cart is moved toward the platform, the guide element on the cart interacts with the guide member on the platform to position the cart on the lift system.

2. The system of claim 1, wherein the guide element includes at least one guide panel connected to the bottom of the cart.

3. The system of claim 2, wherein the guide panel includes a first portion angled with respect to a second portion.

4. The system of claim 1, wherein the guide member includes at least one projection extending from the platform and having at least one tapered side.

5. The system of claim 1, wherein the lift system includes a first base member, a second base member, and a first lift device configured to move the second base member towards and away from the first base member.

6. The system of claim 5, further including a second lift device located between the second base member and the platform and configured to move the platform towards and away from the second base member.

7. The system of claim 6, wherein the second lift device is configured to tilt the platform with respect to the second base member.

8. The system of claim 7, wherein the second lift device is substantially wedge shaped when inflated.

9. The system of claim 6, wherein at least one of the first and second lift devices include pneumatic lift bags.

10. The system of claim 1, wherein the lift system includes a rotation device.

11. The system of claim 10, wherein the rotation device includes a turntable.

12. A lift system, comprising:
a first base member and a second base member;
a first pneumatic lift device configured to elevate the second base member with respect to the first base member;
a lift platform attached to the second base member; and
at least one guide member.

13. The system of claim 12, including a second pneumatic lift device located between the second base member and the lift platform, with the second lift device configured to tilt the lift platform.

14. The system of claim 13, wherein the second lift device includes at least one wedge-shaped pneumatic lift bag.

15. The system of claim 12, including a cart having at least one guide element, wherein the guide element is configured to interact with the guide member to position the cart on the lift system.

16. The system of claim 15, wherein the guide element includes at least one guide panel having a first portion angled with respect to a second portion.

17. The system of claim 15, wherein the guide member includes at least one projection extending from the platform and having at least one tapered side.

18. The system of claim 12, including a rotation device configured to rotate the lift system.

19. A lift system, comprising:
a first base member and a second base member;
a first pneumatic lift device configured to elevate the second base member with respect to the first base member, the first lift device comprising at least one pneumatic lift bag;
a lift platform attached to the second base member;
a second pneumatic lift device located between the second base member and the lift platform, with the second lift device configured to tilt the lift platform, the second lift device comprising at least one lift bag which, when inflated, is substantially wedge shaped; and
at least one guide member.

20. A lift system, comprising:
a first base member and a second base member;
a first pneumatic lift device configured to elevate the second base member with respect to the first base member;
a lift platform attached to the second base member;
a rotation device attached to the first base member; and
at least one guide member.

21. A method of supplying parts, comprising:
providing a cart having at least one guide element;
providing a lift system, comprising:
a first base member;
a second base member;
at least one lift device located between the first and second base members and configured to move the second base member relative to the first base member;
a lift platform carried on the second base member; and
a guide member;
moving the cart such that the guide element interacts with the guide member to position the cart over the lift system; and
activating the lift system to at least one of raise and tilt the cart on the lift system.
